(19) United States
(12) Patent Application Publication
(10) Pub. No.: US 2012/0016155 A1
(43) Pub. Date: Jan. 19, 2012

(54) DIASTEREOISOMERS OF HYPOPHOSPHOROUS ACID DERIVATIVES

(76) Inventors: Francine Acher, Vaucresson (FR); Chelliah Selvam, Sivagangai (IN); Jean-Philippe Pin, Montpellier (FR)

(21) Appl. No.: 13/138,703

(22) PCT Filed: Mar. 19, 2010
(86) PCT No.: PCT/IB2010/051200

§ 371 Date: Sep. 20, 2011

Related U.S. Application Data
(60) Provisional application No. 61/161,849, filed on Mar. 20, 2009.

(51) Int. Cl. C07F 9/28

(52) U.S. Cl. 562/11

(57) ABSTRACT

The invention relates to the diastereoisomers of hypophosphorous acid derivatives, having formula (I), wherein the phenyl group is substituted by one or several atoms or groups, occupying one or several positions on the phenyl ring, and a method for the separation thereof.

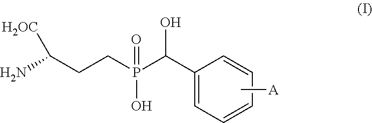

The invention relates to hypophosphorous acid derivatives, and the pharmaceutically acceptable salts thereof, having agonist or antagonist properties for metabotropic glutamate receptors (mGluRs), in particular agonist or antagonist properties for group III, subtype 4, metabotropic glutamate receptors (mGlu4Rs).

More particularly, the invention relates to the diastereoisomers thereof.

WO 2007/052169 in the name of CNRS relates to such a kind of derivatives. The content of which is incorporated herein as reference.

Most of these molecules have chiral center(s) and may exist under the form of diastereoisomers.

It is an object of the invention to provide such diastereoisomers, as new molecules.

It is another object to provide a method of separation of the diastereoisomers of said molecules.

The invention also relates to the use of these diastereoisomers as drugs.

The diastereoisomers of the invention have formula (I)

wherein the phenyl group is substituted by one or several atoms or groups, occupying one or several positions on the phenyl ring.

Preferred substituents comprise alkoxy groups —COA, with A being a C1-C12 alkyl, optionally substituted, for example by a functional group such as a carboxyl group.

The invention also relates to a method for obtaining said diastereoismers, comprising performing a semi-preparative HPLC chromatography in a column, at a pH of 1.5 to 2.5, at a flow rate of 1-2.5 mL.min⁻¹.

Preferably the pH is of about 2.0 and the flow rate of about 1.5-2 mL min⁻¹.

Advantageously the HPLC column comprises an injection loop of appropriate volume. It also further comprises a dual UV detection, particularly at 210 and 254 nm.

As shown in the Experimental part, two types of derivatives are obtained, a first type wherein the diastereoisomers have the same activity and a second type wherein the diastereoisomers have different activities.

In the first group, the absence of benzylic OH or the substitution by a —NH₂ group at the same position has no effect.

On the contrary, in the second group, one of the diastereoisomers is more active. Furthermore, the absence of the benzylic OH or its substitution with —NH₂ induces a loss of activity.

More particularly, the invention relates to the diastereoisomers of (3S)-3-[(((3-ammonium-3-carboxy)propyl)(hydroxy)phosphinyl)-hydroxymethyl]3-nitrobenzene hydrochloride; (3S)-3-[(((3-ammonium-3-carboxy)propyl)(hydroxy)phosphinyl)-hydroxymethyl]-4-hydroxy-3-nitrobenzene hydrochloride; (3S)-3-[(((3-ammonium-3-carboxy)propyl)(hydroxy)phosphinyl)-hydroxymethyl]-4-hydroxy-5-methoxy-3-nitrobenzene hydrochloride; (3S)-3-[(((3-ammonium-3-carboxy)propyl)(hydroxy)phosphinyl)-hydroxymethyl]-4-hydroxy-5-ethoxy-3-nitrobenzene hydrochloride.

The invention also relates to the use of these diastereoisomers as active principle of drugs.

Other characteristics and advantages of the invention are given in the following examples:

### EXPERIMENTAL PART

### Example 1

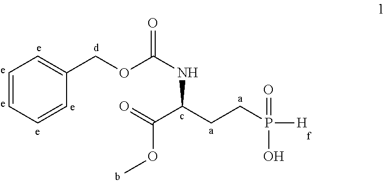

### Methyl(2S)-2-(N-benzyloxycarbonyl)amino-4-[(hydroxy)-phosphinyl]butanoate 1

A mixture of N-benzyloxycarbonyl-L-α-vinylglycine methyl ester (Z-L-α-vinylGlyOMe, 249 mg, 1 mmol), hypophosphorous acid (H₃PO₂ 50% aqueous, 1.040 mL, 10 mmol) and α,α′-azoisobutyronitrile (AIBN, 16 mg, 0.1 mmol) in methanol (1 mL) was refluxed at 80° C. for 5 h. Then the methanol was evaporated under vacuum, and the residue was treated with 10 mL of water and extracted with 125 mL of ethyl acetate. The organic layer was washed with 2×10 mL of water, dried over anhydrous magnesium sulfate, and evaporated under vacuum to afford 1 (315 mg, quantitative yield)

¹H NMR (250 MHz, CD₃OD): δ (ppm)=1.54-2.40 (m; 4H; Hₐ), 3.76 (s; 3H; H_{b}), 4.29 (bs; 1H; 5.13 (s; 2H; H_{d}), 7.05 (d; 1H; J=538 Hz; H_{f}), 7.55 (s; 5H; Hₑ)

³¹P NMR (101 MHz, CD₃OD): δ (ppm)=33.6

### Example 2

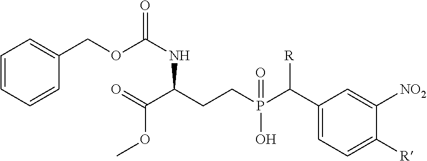

### General Procedure A (R═H or OH, R′═H or OMe):

To a solution of 1 (1 mmol) and 2.2 mmol of aldehyde (R═OH) or bromide (R═H) in 2 mL of dry dichloromethane at 0° C. under argon was added dropwise N,O-bis(trimethylsilyl)-acetamide (BSA, 1.08 mL, 4.4 mmol). The mixture was allowed to warm to room temperature and stirred overnight under argon, then cooled to 0° C. and 20 mL of hydrochloric acid 1N were added, then extracted with 2×100 mL of ethyl acetate. The organic layer was concentrated under vacuum, then the residue was dissolved in 10 mL of water and 10 mL of saturated sodium hydrogen carbonate solution, then washed with 100 mL of ethyl acetate. The organic layer was extracted with 2×(5 mL of water and 5 mL of saturated sodium hydrogen carbonate solution). The combined aqueous layers were treated with hydrochloric acid 37% to adjust pH to 1, then the aqueous phase was extracted twice with 100 mL of ethyl acetate. The combined acidic organic extracts were dried over magnesium sulfate, filtered and concentrated in vacuo.

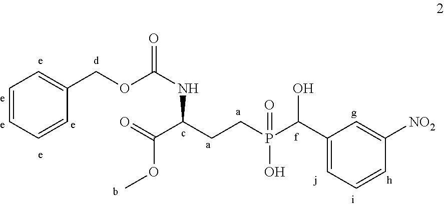

### (3S)-3-[(((3-(N-benzyloxycarbonyl)amino-3-methoxycarbonyl)propyl)(hydroxyl)phosphinyl)-hydroxymethyl]-3-nitrobenzene 2

The compound was prepared according to general procedure A with 248 mg (0.77 mmol) of 1 and 261 mg (1.71 mmol) of 3-nitrobenzaldehyde. 281 mg (yield 76%) of a white solid were obtained.

¹H NMR (250 MHz, CD₃OD): δ (ppm)=1.2-2.3 (m; 4H; Hₐ), 3.73 (s; 3H; H_{b}), 4.26 (bs; 1H; 5.03 (d; 1H; J=10.1 Hz; H_{f}), 5.12 (s; 2H; Hₐ), 7.37 (s; 5H; Hₑ), 7.60 (tₐₚₚ; 1H; J=7.7 Hz; Hᵢ), 7.89 (d; 1H; J=7.0 Hz; Hⱼ), 8.17 (d; 1H; J=8.2 Hz; Hₕ), 8.41 (s; 1H, H_{g})

³¹P NMR (101 MHz, CD₃OD): δ (ppm)=47.6

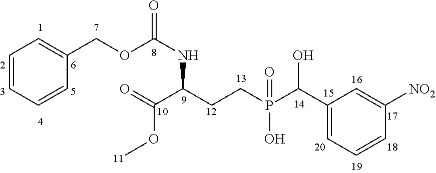

¹³C NMR (63 MHz, CD₃OD): δ (ppm)=25.5 (d; J=113 Hz; C₁₃), 37.5 (C₁₂), 45.7 (C₁₁), 52.7 (C₉), 68.0 (C₇), 74.8 (d; J=104 Hz; C₁₄), 122.9 (C_{16 or 18}), 123.1 (C_{16 or 18}), 129.2 (C_{1 and 5}), 129.4 (C₃), 129.9 (C₂₋₁₄), 130.1 (C₁₉), 134.7 (C₂₀), 138.6 (C₁₅), 144.6 (C₆), 149.8 (Cy), 159.0 (C₈), 176.0 (C₁₀)

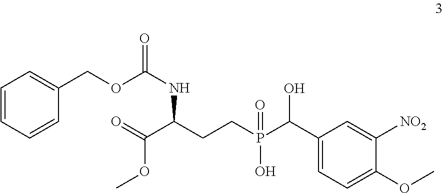

### (3S)-3-[(((3-(N-benzyloxycarbonyl)amino-3-methoxycarbonyl)propyl)(hydroxyl)phosphinyl)-hydroxymethyl]-4-methoxy-3-nitrobenzene 3

The compound was prepared according to general procedure A with 315 mg (1 mmol) of 1 and 736 mg (4 mmol) of 4-methoxy-3-nitrobenzaldehyde. The crude product is directly deprotected without further purification.

³¹P NMR (101 MHz, CD₃OD): δ (ppm)=47.2

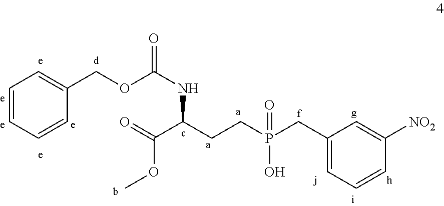

### 3-nitrobenzyl((S)-3-(benzyloxycarbonyl)amino-3-methoxycarbonylpropyl)phosphinic acid 4

The compound was prepared according to general procedure A with 258 mg (0.82 mmol) of 1 and 389 mg (1.8 mmol) of 3-nitrobenzylbromide. 272 mg (yield 74%) of a pale yellow solid were obtained.

¹H NMR (250 MHz, CD₃OD): δ (ppm)=1.70-2.30 (m; 4H; Hₐ), 3.29 (m; 2H; H_{f}), 3.73 (s; 3H_{b}), 4.25 (bs; 1H; H_{c}), 5.11 (s; 2H; H_{d}), 7.36 (s; 5H; Hₑ), 7.56 (t; 1H; J=7.9 Hz; Hᵢ), 7.72 (d; 1H; J=7.2 Hz; Hⱼ), 8.14 (d; 1H; J=8.3 Hz; Hₕ), 8.23 (s; 1H; H_{g})

³¹P NMR (101 MHz, CD₃OD): δ (ppm)=48.1

### Example 3

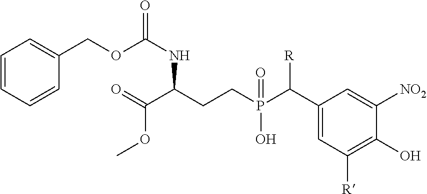

### General Procedure B (R═H or OH, R′═H or OMe):

To a solution of 1 (1 mmol) and 2.2 mmol of aldehyde (R═OH) or bromide (R═H) in 2 mL of dry dichloromethane at 0° C. under argon was added dropwise N,O-bis(trimethylsilyl)-acetamide (BSA, 1.08 mL, 4.4 mmol). The mixture was allowed to warm to room temperature and stirred overnight under argon, then cooled to 0° C. and 20 mL of hydrochloric acid 1N were added, then extracted with 2×100 mL of ethyl acetate. The combined organic extracts were dried over magnesium sulfate, filtered and concentrated in vacuo.

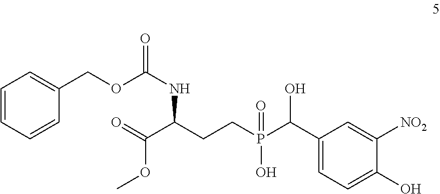

### (3S)-3-[(((3-(N-benzyloxycarbonyl)amino-3-methoxycarbonyl)propyl)(hydroxy)phosphinyl)-hydroxymethyl]-4-hydroxy-3-nitrobenzene 5

The compound was prepared according to general procedure B with 277 mg (0.88 mmol) of 1 and 323 mg (1.93 mmol) of 4-hydroxy-3-nitrobenzaldehyde. The crude product, still containing aldehyde in excess, was directly deprotected.

³¹P NMR (101 MHz, CD₃OD): δ (ppm)=48.8

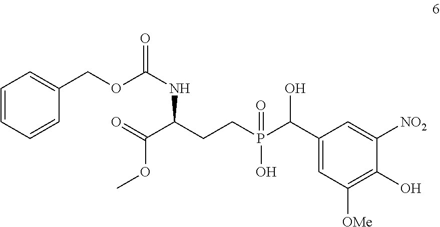

### (3S)-3-[(((3-(N-benzyloxycarbonyl)amino-3-methoxycarbonyl)propyl)(hydroxy)phosphinyl)-hydroxymethyl]-4-hydroxy-5-methoxy-3-nitrobenzene 6

The compound was prepared according to general procedure B with 292 mg (0.93 mmol) of 1 and 568 mg (2.79 mmol) of 4-hydroxy-5-methoxy-3-nitrobenzaldehyde (5-nitrovanillin). The crude product, still containing aldehyde in excess, was directly deprotected.

³¹P NMR (101 MHz, CD₃OD): δ (ppm)=49.3

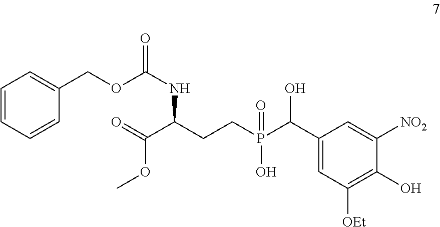

### (3S)-3-[(((3-(N-benzyloxycarbonyl)amino-3-methoxycarbonyl)propyl)(hydroxy)phosphinyl)-hydroxymethyl]-4-hydroxy-5-ethoxy-3-nitrobenzene 7

The compound was prepared according to general procedure B with 295 mg (0.94 mmol) of 1 and 435 mg (2.06 mmol) of 4-hydroxy-5-ethoxy-3-nitrobenzaldehyde. The crude product, still containing aldehyde in excess, was directly deprotected.

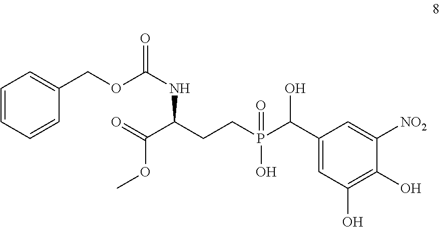

### (3S)-3-[(0-(N-benzyloxycarbonyl)amino-3-methoxycarbonyl)propyl)(hydroxyl)phosphinyl)-hydroxymethyl]-4,5-dihydroxy-3-nitrobenzene 8

The compound was prepared according to general procedure B with 233 mg (0.74 mmol) of 1 and 298 mg (1.63 mmol) of 3,4-dihydroxy-5-nitrobenzaldehyde. The crude product, still containing aldehyde in excess, was directly deprotected.

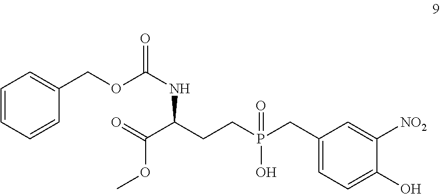

### 4-hydroxy-3-nitrobenzyl(S)-3-(benzyloxycarbonyl)amino-3-methoxycarbonylpropyl) phosphinic acid 9

The compound was prepared according to general procedure B with 315 mg (1 mmol) of 1 and 433 mg (1.87 mmol) of 4-hydroxy-3-nitrobenzylbromide. The crude product, still containing aldehyde in excess, was directly deprotected.

³¹P NMR (101 MHz, CD₃OD): δ (ppm)=51.8

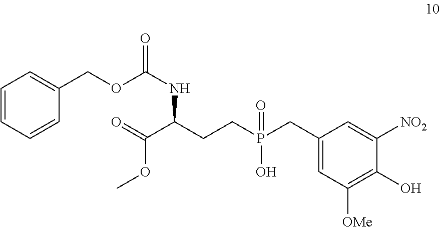

### 4-hydroxy-5-methoxy-3-nitrobenzyl(S)-3-(benzyloxycarbonyl)amino-3-methoxycarbonylpropyl) phosphinic acid 10

The compound was prepared according to general procedure B with 315 mg (1 mmol) of 1 and 416 mg (1.59 mmol) of 4-hydroxy-5-methoxy-3-nitrobenzylbromide. The crude product, still containing aldehyde in excess, was directly deprotected.

³¹P NMR (101 MHz, CD₃OD): δ (ppm)=51.5

### Example 4

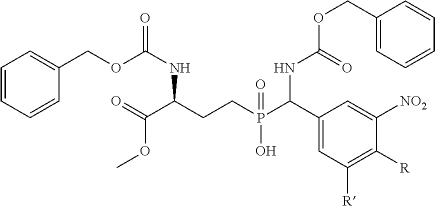

### General Procedure C(R═H or OH, R′═H or OMe):

To a solution of 1 (1 mmol) in acetyl chloride/acetic acid (5/1 mL) under argon was added benzylcarbamate (151 mg, 1 mmol). The mixture was cooled to 0° C. and 1 mmol of aldehyde was added. The mixture was allowed to warm to room temperature and stirred for 5 h under argon, then concentrated to dryness.

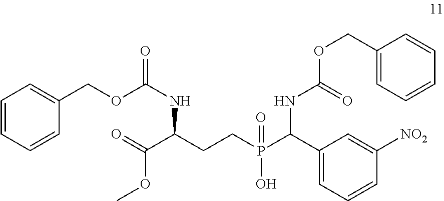

### (benzyloxycarbonylamino)(3-nitrophenyl)methyl((S)-3-(benzyloxycarbonylamino)-3-methoxycarbonylpropyl)phosphinic acid 11

The compound was prepared according to general procedure C with 264 mg (0.84 mmol) of 1, 136 mg (0.9 mmol) of 3-nitrobenzaldehyde and 136 mg (0.9 mmol) of benzylcarbamate.

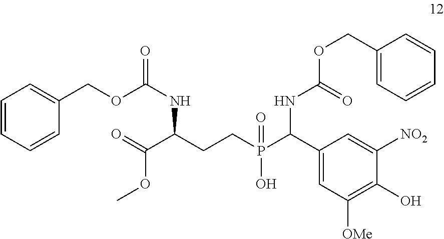

### (benzyloxycarbonylamino)(4-hydroxy-5-methoxy-3-nitrophenyl)methyl((S)-3-(benzyloxycarbonylamino)-3-methoxycarbonylpropyl)phosphinic acid 12

The compound was prepared according to general procedure C with 113 mg (0.36 mmol) of 1, 71 mg (0.36 mmol) of 4-hydroxy-5-methoxy-3-nitrobenzaldehyde and 54 mg (0.36 mmol) of benzylcarbamate.

³¹P NMR (101 MHz, CD₃OD): δ (ppm)=51.7

### Example 5

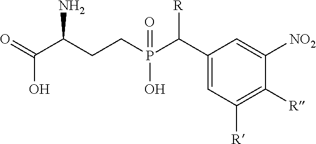

### General Procedure D (R═H or OH or NH₂, R′═H or OMe, R″═H or OH or OMe):

The crude product synthesised by general procedure A, B or C was dissolved in 5 mL of hydrochloric acid 6N. The mixture was stirred at 100° C. for 5 h, then cooled to room temperature. The solution was diluted with 50 mL of ethyl acetate and 10 mL of water. The separated organic layer was extracted with 3×10 mL of hydrochloric acid 1N. The combined aqueous phases were concentrated under vacuum, then the residue was purified using a Dowex AG50x4 cation exchange resin column (H⁺, 50-100 mesh, water elution or 0.5M NH₄OH when R═NH₂).

### Example 6

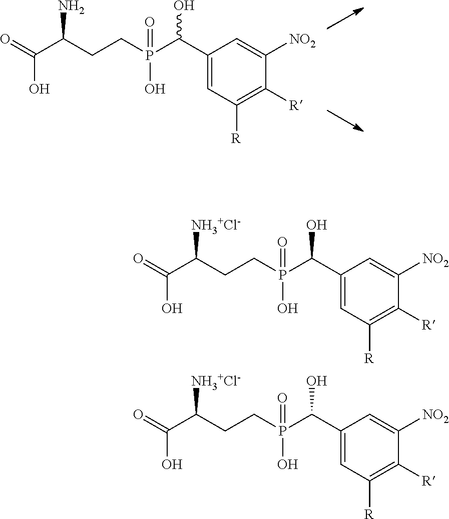

General Procedure E—Diastereoisomers separation (R═H or OMe, R′═H or OH or OMe):

The diastereoisomers were separated using a semi-preparative HPLC column Daicel Crownpak CR(+) 150×10 mm, with a pH 2.0 hydrochloric acid 2 or 1.5 mL.min⁻¹ flow, a 2 mL injection loop, and a dual UV detection at 210 and 254 nm. Several injections were performed in order to obtain enough product for pharmacological tests. The diasteroisomer with the shortest retention time was named -I and the other one -II.

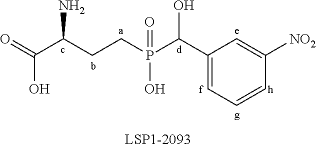

### (3S)-3-[(((3-ammonium-3-carboxy)propyl)(hydroxy)phosphinyl)-hydroxymethyl]3-nitrobenzene LSP1-2093

260 mg of product 2 were deprotected according to general procedure D. 72 mg of pure product LSP1-2093 were obtained (42% yield).

³¹P NMR (101 MHz, CD₃OD): δ (ppm)=49.7

¹H NMR (250 MHz, CD₃OD): δ (ppm)=1.72 (m; 2H; Hₐ), 2.09 (m; 2H; H_{b}), 4.01 (m; 1H; H_{c}), 4.94 (d; 1H; J=9.6 Hz; H_{d}), 7.53 (t; 1H; J=8.0 Hz; H_{g}), 7.74 (d; 1H; J=7.5 Hz; H_{f}), 8.09 (d; 1H; J=8.2 Hz; Hₕ), 8.22 (s; 1H; Hₑ)

MS (ESI): m/z=317.1 (M−1)

### (3S)-3-[(((3-ammonium-3-carboxy)propyl)(hydroxy)phosphinyl)-hydroxymethyl]3-nitrobenzene hydrochloride LSP3-1098-I and LSP3-1098-II

The diastereoisomers of LSP1-2093 were separated according to general procedure E, at 23° C. with a 2 mL.min⁻¹ flow. Each injection was prepared with 9 mg of LSP1-2093 in 1.8 mL of pH 2.0 hydrochloric acid. After 3 injections, 12 mg of each diastereoisomer were obtained.

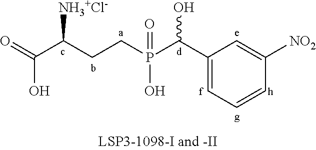

### LSP3-1098-I:

¹H NMR (500 MHz, D₂O): δ (ppm)=1.83 (m; 2H; Hₐ), 2.11 (s; 2H; H_{b}), 4.07 (t; 1H; J=6.0 Hz; H_{c}), 5.04 (d; 1H; J=9.5 Hz; H_{d}), 7.56 (tₐₚₚ; 1H; J=7.9 Hz; H_{g}), 7.76 (d; 1H; J=7.3 Hz; H_{f}), 8.14 (d; 1H; J=7.9 Hz; Hₕ), 8.22 (s; 1H; Hₑ)

MS (ESI): m/z=317.1 (M−1−HCl)

[α]_{D}²⁰=−2° (H₂0, λ=589 nm, C=6 mg.mL⁻¹)

HPLC (Crownpak CR(+), 150×4 mm, HClO₄ pH 2.0, 0.4 mL.min⁻¹, T=21° C., detection λ=210/254 nm): tᵣ=16.7 min

### LSP3-1098-II:

¹H NMR (500 MHz, D₂O): δ (ppm)=1.78 (d; 1H; J=12.0 Hz; Hₐ), 1.94 (d; 1H; J=11.7 Hz; H_{a′}), 2.12 (dd; 2H; J=10.0/23.3 Hz; H_{b}), 4.06 (s; 1H; H_{c}), 6.06 (d; 1H; J=8.5 Hz; H_{d}), 7.56 (tₐₚₚ; 1H; J=7.4 Hz; H_{g}), 7.75 (d; 1H; J=6.3 Hz; H_{f}), 8.14 (d; 1H; J=6.9 Hz; Hₕ), 8.22 (s; 1H; Hₑ)

MS (ESI): m/z=317.1 (M−1−HCl)

[α]_{D}²⁰=+29° (H₂0, λ=589 nm, C=6 mg.mL⁻¹)

HPLC (Crownpak CR(+), 150×4 mm, HClO₄ pH 2.0, 0.4 mL.min⁻¹, T=21° C., detection λ=210/254 nm): tᵣ=21.4 min

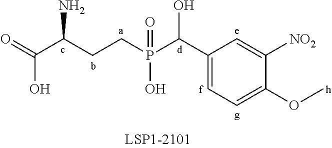

### (3S)-3-[(((3-amino-3-carboxy)propyl) (hydroxy)phosphinyl)-hydroxymethyl]-4-methoxy-3-nitrobenzene LSP1-2101

The crude product 3 was deprotected according to general procedure D. 304 mg of pure product LSP1-2101 were obtained (87% yield, 2 steps).

³¹P NMR (101 MHz, D₂O): δ (ppm)=50.7

¹H NMR (500 MHz, D₂O): δ (ppm)=1.61-1.84 (m; 2H; Hₐ), 2.03-2.19 (m; 2H; H_{b}), 3.92 (bs; 1H; H_{c}), 3.94 (s; 3H; Hₕ), 4.83 (d; 1H; J=8.7 Hz; H_{d}), 7.29 (d; 1H, J=8.3 Hz; H_{f}), 7.67 (d; 1H, J=8.3 Hz; H_{g}), 7.97 (s; 1H; Hₑ)

¹³C NMR (126 MHz, D₂O): δ (ppm)=24.2 and 24.4 (2d; J=90.2 Hz; C₄), 24.8 (C₃), 55.6 (C₂), 58.2 (C₁₂), 72.9 (d; J=108.2 Hz; C₅), 115.9 (C₁₀), 125.7 (C₇), 132.3 (C₆), 135.5 (C₁₁), 139.6 (C₈), 154.0 (C₉), 174.0 (C₁)

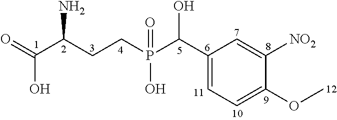

MS (ESI): m/z=349.1 (M+1)

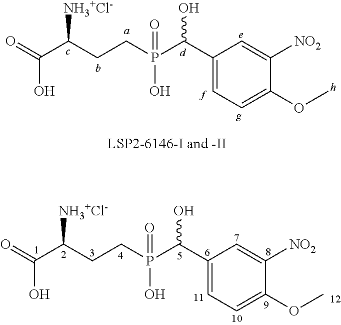

### (3S)-3-[(((3-ammonium-3-carboxy)propyl)(hydroxy)phosphinyl)-hydroxymethyl]3-nitrobenzene hydrochloride LSP2-6146-I and LSP2-6146-II

The diastereoisomers of LSP1-2101 were separated according to general procedure E, at 7° C. with a 1.5 mL.min⁻¹ flow. The temperature was regulated with a Peltier effect thermostat Igloo-CIL. Each injection was prepared with 6 mg of LSP1-2101 in 1.5 mL of pH 2.0 hydrochloric acid. After a dozen of injections, 37 mg of diastereoisomer 1 and 36 mg of diastereoisomer II were obtained.

### LSP2-6146-I:

³¹P NMR (101 MHz, D₂O): δ (ppm)=42.5

¹H NMR (500 MHz, D₂O): δ (ppm)=1.78-1.94 (m; 2H; Hₐ), 2.09-2.17 (m; 2H; H_{b}), 3.94 (s; 3H; Hₕ), 4.10 (t; 1H; J=5.3 Hz; H_{c}), 4.97 (d; 1H; J=8.1 Hz; H_{d}), 7.29 (d; 1H; J=8.4 Hz; H_{f}), 7.67 (d; 1H; J=8.3 Hz; H_{g}), 7.97 (s; 1H; Hₑ)

¹³C NMR (126 MHz, D₂O): δ (ppm)=23.4 (C₄), 24.0 (C₃), 54.0 (C₂), 58.5 (C₁₂), 71.9 (d; J=110.2 Hz; C₅), 116.0 (d; J=21.6 Hz; C₁₀), 125.7 (d; J=19.6 Hz; C₇), 130.5 (C₆), 135.4 (d; J=19.5 Hz; C₁₁), 139.6 (C₈), 154.3 (C₉), 172.5 (C₁)

[α]_{D}²⁰=−4.5° (H₂0, λ=589 nm, C=10 mg.mL⁻¹)

HPLC (Crownpak CR(+), 150×4 mm, HClO₄ pH 2.0, 0.4 mL.min⁻¹, T=10° C., detection λ=210/254 nm): tᵣ=67.1 min

### LSP2-6146-II:

³¹P NMR (101 MHz, D₂O): δ (ppm)=42.1

¹H NMR (500 MHz, D₂O): δ (ppm)=1.81 (bs; 1H; Hₐ), 1.93 (bs; 1H; H_{a′}), 2.14 (bs; 2H; H_{b}), 3.85 (s; 3H; Hₕ), 4.16 (bs; 1H; H_{c}), 4.96 (bs; 1H; H_{d}), 7.29 (bs; 1H, H_{f}), 7.67 (bs; 1H, H_{g}), 7.96 (bs; 1H; Hₑ)

¹³C NMR (126 MHz, D₂O): δ (ppm)=22.9 (d; J=88 Hz; C₄), 24.0 (C₃), 54.4 (d; J=13.5 Hz; C₂), 58.3 (C₁₂), 71.9 (d; J=111.1 Hz, C₅), 116.0 (C₁₀), 125.8 (C₇), 130.5 (C₆), 135.5 (C₁₁), 139.6 (C₈), 154.3 (C₉), 172.6 (C₁)

[α]_{D}²⁰=+19.4° (H₂0, λ=589 nm, C=10 mg.mL⁻¹)

HPLC (Crownpak CR(+), 150×4 mm, HClO₄ pH 2.0, 0.4 mL.min⁻¹, T=10° C., detection λ=210/254 nm): tᵣ=81.9 min

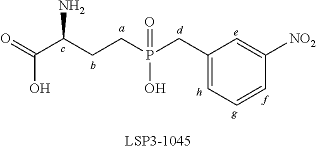

### (3S)-3-[(((3-ammonium-3-carboxy)propyl) (hydroxy)phosphinyl)-methyl]3-nitrobenzene LSP3-1045

272 mg (0.86 mmol) of compound 4 were deprotected according to general procedure D. 140 mg of pure product LSP3-1045 were obtained (54% yield).

³¹P NMR (101 MHz, D₂O): δ (ppm)=52.7

¹H NMR (250 MHz, D₂O): δ (ppm)=1.55-1.84 (m; 2H; Hₐ), 2.03-2.16 (m; 2H; H_{b}), 3.20 (d; 2H; J=16.5 Hz; H_{d}), 4.00 (t; 1H; J=6.0 Hz; H_{c}), 7.54 (t; 1H; J=8.0 Hz; H_{g}), 7.65 (d; 1H; J=7.5 Hz; Hₕ), 8.09-8.12 (m; 2H; H_{e-f})

¹³C NMR (63 MHz, D₂O+NH₃ for solubilization): δ (ppm)=25.4, 26.9, 28.5, 37.4, 38.7, 121.8, 124.8, 130.1, 136.9, 137.6, 148.4

MS (ESI): m/z=301.1 (M−1) [α]_{D}²⁰=+2° (H₂0, λ=589 nm, C=5 mg.mL⁻¹)

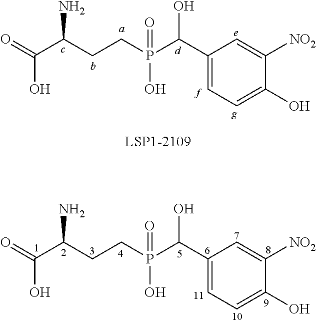

### (3S)-3-[(((3-amino-3-carboxy)propyl) (hydroxy)phosphinyl)-hydroxymethyl]-4-hydroxy-3-nitrobenzene LSP1-2109

The crude product 5 was deprotected according to general procedure D. 116 mg of pure product LSP1-2109 were obtained (39% yield, 2 steps).

³¹P NMR (101 MHz, D₂O): δ (ppm)=48.7

¹H NMR (250 MHz, D₂O): δ (ppm)=1.78 (m; 2H; Hₐ), 2.05 (m; 2H; H_{b}), 3.98 (m; 1H; H_{c}), 4.80 (d; 1H; J=8.6 Hz; H_{d}), 7.06 (d; 1H; J=8.7 Hz; H_{f}), 7.57 (d; 1H; J=8.6 Hz; H_{g}), 8.02 (s; 1H; Hₑ)

¹³C NMR (63 MHz, D₂O): δ (ppm)=22.6 (d; J=88.4 Hz; C₄), 23.61 (C₃), 53.98 (d; J=14.7 Hz; C₂), 71.8 (d; J=107.4 Hz, C₅), 120.0 (C₁₀), 123.7 (C₇), 130.8 (C₆), 134.3 (C₈), 136.8 (C₁₁), 153.3 (C₉), 172.4 (C₁)

MS (ESI): m/z=333.0 (M−1)

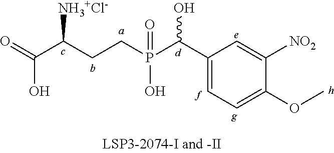

### (3S)-3-[(((3-ammonium-3-carboxy)propyl)(hydroxy)phosphinyl)-hydroxymethyl]4-hydroxy-3-nitrobenzene hydrochloride LSP3-2074-I and LSP3-2074-II

The diastereoisomers of LSP1-2109 were separated according to general procedure E, at 5° C. with a 2 mL.min⁻¹ flow. The temperature was regulated with a Peltier effect thermostat Igloo-CIL. Each injection was prepared with 5 mg or LSP1-2109 in 1.5 mL of pH 2.0 hydrochloric acid. After 7 injections, 16 mg of diastereoisomer 1 and 18 mg of diastereoisomer II were obtained.

### LSP3-2074-I:

³¹P NMR (101 MHz, D₂O): δ (ppm)=54.6

¹H NMR (500 MHz, D₂O): δ (ppm)=1.88 (bs; 2H; Hₐ), 2.13 (bs; 2H; H_{b}), 4.09 (s; 1H; H_{c}), 4.96 (d; 1H; J=6.5 Hz; H_{d}), 7.14 (d; 1H; J=7.0 Hz; H_{f}), 7.63 (d; 1H; J=6.0 Hz; H_{g}), 8.09 (s; 1H; Hₑ)

[α]_{D}²⁰=+1.5° (H₂0, λ=589 nm, C=8 mg.mL⁻¹)

HPLC (Crownpak CR(+), 150×4 mm, HClO₄ pH 2.0, 0.4 mL.min⁻¹, T=10° C., detection λ=210/254 nm): tᵣ=19.1 min

### LSP3-2074-II:

³¹P NMR (101 MHz, D₂O): δ (ppm)=53.2

¹H NMR (500 MHz, D₂O): δ (ppm)=1.79 (bs; 1H; Hₐ), 1.91 (bs; 1H; H_{a′}), 2.13 (bs; 2H; H_{b}), 4.07 (s; 1H; H_{c}), 4.93 (d; 1H; J=2.0 Hz; H_{d}), 7.15 (d; 1H; J=2.5 Hz; H_{f}), 7.63 (d; 1H; J=2.5 Hz; H_{g}), 8.09 (s; 1H; Hₑ)

[α]_{D}²⁰=+21.9° (H₂0, λ=589 nm, C=8 mg.mL⁻¹)

HPLC (Crownpak CR(+), 150×4 mm, HClO₄ pH 2.0, 0.4 mL.min⁻¹, T=10° C., detection λ=210/254 nm): tᵣ=24.3 min

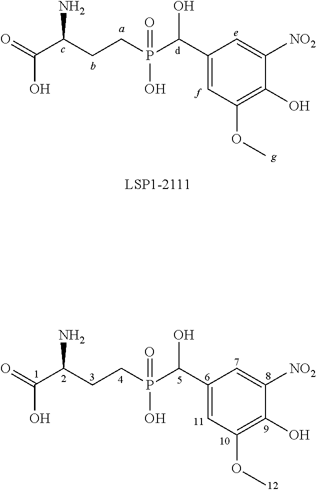

### (3S)-3-[(((3-ammonium-3-carboxy)propyl)(hydroxy)phosphinyl)-hydroxymethyl]4-hydroxy-5-methoxy-3-nitrobenzene LSP1-2111

The crude product 6 was deprotected according to general procedure D. 196 mg of pure product LSP1-2111 were obtained (58% yield, 2 steps).

³¹P NMR (101 MHz, D₂O): δ (ppm)=50.0

¹H NMR (250 MHz, D₂O): δ (ppm)=1.70 (m; 2H; Hₐ), 2.05 (m; 2H; H_{b}), 3.84 (s; 3H; H_{g}), 3.97 (m; 1H; H_{c}), 7.25 (s; 1H; H_{f}), 7.60 (s; 1H; Hₑ)

¹³C NMR (63 MHz, D₂O): δ (ppm)=22.6 (d; J=90.4 Hz; C₄), 23.7 (C₃), 54.2 (d; J=12.7 Hz; C₂), 56.9 (C₁₂), 72.1 (d; J=109.9 Hz, C₅), 114.4 (C₇), 116.8 (C₁₁), 130.0 (C_{6 or 8}), 134.2 (C_{8 or 6}), 143.9 (C_{9 or 10}), 149.3 (C_{9 or 10}), 172.6 (C₁)

MS (ESI): m/z=365.1 (M+1)

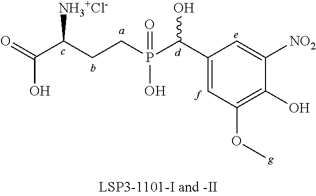

### (3S)-3-[(((3-ammonium-3-carboxy)propyl)(hydroxy)phosphinyl)-hydroxymethyl]4-hydroxy-5-methoxy-3-nitrobenzene hydrochloride LSP3-1101-I and LSP3-1101-II

The diastereoisomers of LSP1-2111 were separated according to general procedure E, at 21° C. with a 2 mL.min⁻¹ flow. Each injection was prepared with 5 mg of LSP1-2111 in 1.8 mL of pH 2.0 hydrochloric acid. After 7 injections, 15 mg of diastereoisomer 1 and 14 mg of diastereoisomer II were obtained.

### LSP3-1101-I:

¹H NMR (500 MHz, D₂O): δ (ppm)=1.83 (s; 2H; Hₐ), 2.11 (s; 2H; H_{b}), 3.89 (s; 3H; H_{g}), 4.07 (s; 1H; H_{c}), 4.90 (s; 1H; H_{d}), 7.31 (s; 1H; H_{f}), 7.67 (s; 1H; H_{c})

[α]_{D}²⁰=+2° (H₂0, λ=589 nm, C=7.5 mg.mL⁻¹)

HPLC (Crownpak CR(+), 150×4 mm, HClO₄ pH 2.0, 0.4 mL.min⁻¹, T=21° C., detection λ=210/254 nm): tᵣ=21.4 min

### LSP3-1101-II:

¹H NMR (500 MHz, D₂O): δ (ppm)=1.81 (d; 1H; J=12.9 Hz; Hₐ), 1.93 (d; 1H; J=11.7 Hz; H_{a′}), 2.13 (s; 1H; H_{b}), 3.89 (s; 3H; H_{g}), 4.07 (t; 1H; J=5.0 Hz; H_{c}), 4.92 (d; 1H; J=7.6 Hz; H_{d}), 7.30 (s; 1H; H_{f}), 7.67 (s; 1H; Hₑ)

[α]_{D}²⁰=+25° (H₂0, λ=589 nm, C=7 mg.mL⁻¹)

HPLC (Crownpak CR(+), 150×4 mm, HClO₄ pH 2.0, 0.4 mL.min⁻¹, T=21° C., detection λ=210/254 nm): tᵣ=25.0 min

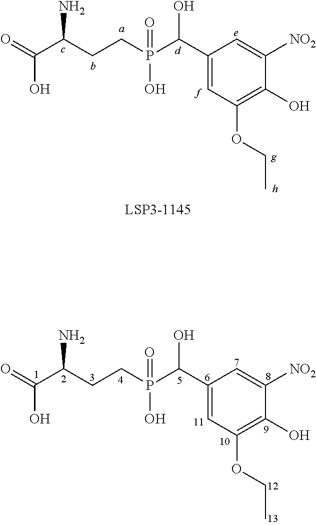

### (3S)-3-[(((3-ammonium-3-carboxy)propyl)(hydroxy)phosphinyl)-hydroxymethyl]4-hydroxy-5-ethoxy-3-nitrobenzene LSP3-1145

The crude product 7 was deprotected according to general procedure D. 2 cation exchange columns were necessary in order to obtain a pure compound. 111 mg of pure product LSP3-1145 were obtained (31% yield, 2 steps).

³¹P NMR (101 MHz, D₂O): δ (ppm)=49.5

¹H NMR (500 MHz, D₂O): δ (ppm)=1.37 (t; 3H; J=6.5 Hz; Hₕ), 1.68-1.80 (m; 2H; Hₐ), 2.08 (bs; 2H; H_{b}), 3.99 (s; 1H; H_{c}), 4.13 (q; 2H; J=6.5 Hz; H_{g}), 4.78 (d; 1H; J=8.0 Hz; H_{d}), 7.27 (s; 1H; H_{f}), 7.62 (s; 1H; Hₑ)

¹³C NMR (126 MHz, D₂O): δ (ppm)=15.2 (d; J=12.5 Hz; C₁₃), 23.3 and 24.0 (2d; J=48 Hz; C₄), 24.6 (C₃), 55.1 (C₂), 67.3 (C₁₂), 72.7 (C₁₂), 73.5 (C₅), 115.6 and 115.7 (C₇), 119.1 and 119.2 (C₁₁), 130.9 (C_{6 or 8}), 135.5 (C_{8 or 6}), 145.1 (C_{9 or 10}), 149.6 (C_{9 or 10}), 173.4 (C₁)

MS (ESI): m/z=376.9 (M−1)

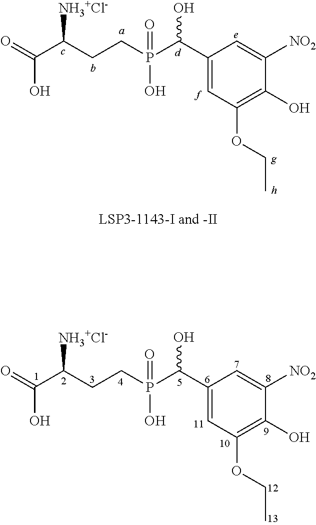

### (3S)-3-[(((3-ammonium-3-carboxy)propyl)(hydroxy)phosphinyl)-hydroxymethyl]4-hydroxy-5-ethoxy-3-nitrobenzene hydrochloride LSP3-1143-I and LSP3-1143-II

The diastereoisomers of LSP3-1145 were separated according to general procedure E, at 25° C. with a 2 mL.min⁻¹ flow. Each injection was prepared with 8 mg of LSP3-1145 in 1.8 mL of pH 2.0 hydrochloric acid. After 15 injections, 40 mg of diastereoisomer I and 46 mg of diastereoisomer II were obtained.

### LSP3-1143-I:

³¹P NMR (101 MHz, D₂O): δ (ppm)=54.0

¹H NMR (500 MHz, D₂O): δ (ppm)=1.35 (s; 3H; Hₕ), 1.83 (bs; 2H; Hₐ), 2.09 (bs; 2H; H_{b}), 4.05 (s; 1H; H_{c}), 4.12 (bs; 2H; H_{g}), 4.87 (s; 1H; Hₐ), 7.25 (s; 1H; H_{f}), 7.63 (s; 1H; Hₑ)

¹³C NMR (126 MHz, D₂O): δ (ppm)=15.2 (C₁₃), 23.1 (d; J=372 Hz; C₄), 24.2 (C₃), 54.8 (C₂), 67.4 (C₁₂), 72.1 (C₁₂), 73.0 (C₅), 115.6 (C₇), 118.9 (C₁₁), 130.1 (C_{6 or 8}), 135.5 (C_{8 or 6}), 145.3 (C_{9 or 10}), 149.7 (C_{9 or 10}), 172.7 (C₁)

[α]_{D}²⁰=+6.4° (H₂0, λ=589 nm, C=17 mg.mL⁻¹)

HPLC (Crownpak CR(+), 150×4 mm, HClO₄ pH 2.0, 0.4 mL.min⁻¹, T=27° C., detection λ=210/254 nm): tᵣ=35.3 min

### LSP3-1143-II:

³¹P NMR (101 MHz, D₂O): δ (ppm)=54.6

¹H NMR (500 MHz, D₂O): δ (ppm)=1.37 (s; 3H; Hₕ), 1.75 (bs; 1H; Hₐ), 1.88 (bs; 1H; H_{a′}), 2.11 (bs; 2H; H_{b}), 4.05 (s; 1H; H_{c}), 4.15 (bs; 2H; H_{g}), 4.87 (s; 1H; H_{d}), 7.30 (s; 1H; H_{f}), 7.66 (s; 1H; Hₑ)

¹³C NMR (126 MHz, D₂O): δ (ppm)=15.2 (C₁₃), 23.7 (m; C₄), 24.4 (C₃), 54.8 (m; C₂), 67.4 (C₁₂), 72.5 (C₁₂), 73.4 (C₅), 115.8 (C₇), 119.1 (C₁₁), 130.5 (C_{6 or 8}), 135.6 (C_{8 or 6}), 145.3 (C_{9 or 10}), 149.7 (C_{9 or 10}), 172.8 (C₁)

[α]_{D}²⁰=+18.3° (H₂0, λ=589 nm, C=14.5 mg.mL⁻¹)

HPLC (Crownpak CR(+), 150×4 mm, HClO₄ pH 2.0, 0.4 mL.min⁻¹, T=27° C., detection λ=210/254 nm): tᵣ=39.7 min

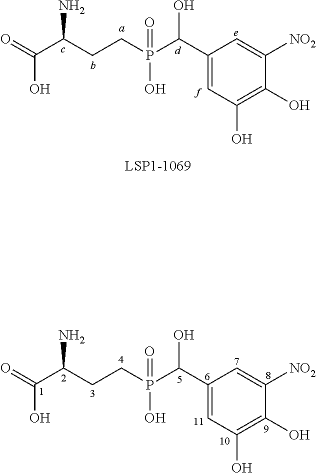

### (3S)-3-[(((3-amino-3-carboxy)propyl)(hydroxy)phosphinyl)-hydroxymethyl]-4,5-dihydroxy-3-nitrobenzene LSP3-1069

The crude product 8 was deprotected according to general procedure D. 2 cation exchange columns were necessary in order to obtain a pure compound. 7 mg of pure product LSP3-1069 were obtained (3% yield, 2 steps).

³¹P NMR (101 MHz, D₂O): δ (ppm)=48.7

¹H NMR (250 MHz, D₂O): δ (ppm)=1.56-2.22 (m; 4H; H_{a/b}), 3.92 (bs; 1H; H_{c}), 7.27 (s; 1H; H_{f}), 7.68 (s; 1H; Hₑ)

¹³C NMR (63 MHz, D₂O+NaOH for solubilisation): δ (ppm)=23.8 (C₄), 24.2 (C₃), 55.6 (C₂), 72.9 (C₅), 114.5 (C₁₁), 118.6 (C₈), 126.5, 134.6, 148.4, 149.7 (C_{6/8/9/10}), 174.6 (C₁)

MS (ESI): m/z=349.0 (M−1)

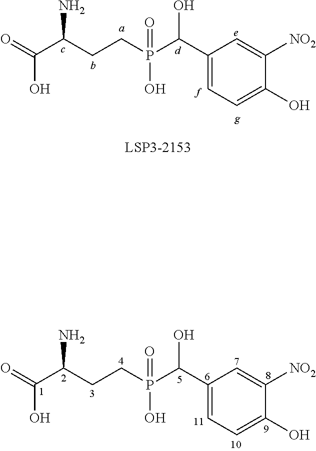

### (3S)-3-[(((3-ammonium-3-carboxy)propyl)(hydroxy)phosphinyl)-methyl]4-hydroxy-3-nitrobenzene LSP3-2153

The crude product 9 was deprotected according to general procedure D. 134 mg of pure product LSP3-2153 were obtained (40% yield, 2 steps).

³¹P NMR (101 MHz, D₂O): δ (ppm)=58.9

¹H NMR (250 MHz, D₂O): δ (ppm)=1.72-1.90 (m; 2H; Hₐ), 2.03-2.12 (m; 2H; H_{b}), 3.13 (d; 2H; J=32 Hz; H_{d}), 4.06 (t; 1H; J=12 Hz; H_{c}), 7.01 (d; 1H; J=17 Hz; H_{f}), 7.43 (d; 1H; J=17 Hz; H_{g}), 7.86 (s; 1H; Hₑ)

¹³C NMR (126 MHz, D₂O): δ (ppm)=24.0 (C₃), 24.9 (d; J=366 Hz; C₄), 36.2 (d; J=362 Hz; C₅), 54.3 (d; J=65 Hz; C₂), 121.4 (C₁₁), 125.7 (C₆), 127.1 (C₇), 135.3 (C₈), 140.2 (C₁₀), 153.7 (C₉), 172.5 (C₁)

MS (ESI): m/z=317.1 (M−1)

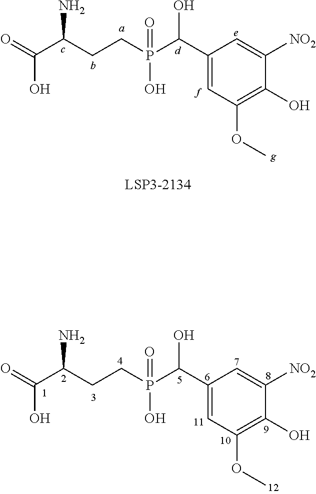

### (3S)-3-[(((3-ammonium-3-carboxy)propyl)(hydroxy)phosphinyl)-methyl]4-hydroxy-5-methoxy-3-nitrobenzene LSP3-2134

The crude product 10 was deprotected according to general procedure D. The cation exchange column was eluted with 1N ammonia. 120 mg of pure product LSP3-2134 were obtained (34% yield, 2 steps).

³¹P NMR (101 MHz, D₂O): δ (ppm)=50.6

¹H NMR (500 MHz, D₂O): δ (ppm)=1.53-1.56 (m; 2H; Hₐ), 1.99-2.03 (m; 2H; H_{b}), 2.84 (d; 2H; J=16 Hz; H_{d}), 3.67 (t; 1H; J=6.0 Hz; H_{c}), 3.80 (s; 1H; H_{g}), 6.92 (s; 1H; H_{f}), 7.38 (s; 1H; Hₑ)

¹³C NMR (126 MHz, D₂O): δ (ppm)=25.3 (C₃), 26.3 (d; J=361 Hz; C₄), 38.4 (d; J=343 Hz; C₅), 56.7 (d; J=54.5 Hz; C₂), 57.6 (C₁₂), 118.5 and 118.8 (C_{7 and 11}), 121.5 (C₆), 136.3, 153.8, 154.7 (C_{8, 9 and 10}), 175.5 (C₁)

MS (ESI): m/z=347.1 (M−1)

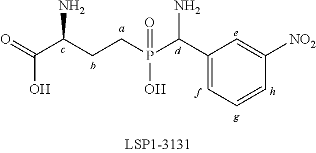

### (2S)-amino-4-[[amino(3-nitrophenyl)methyl](hydroxy)phosphinyl]butanoic acid LSP1-3131

The crude product 11 was deprotected according to general procedure D. The cation exchange column was eluted with 1N ammonia. 3.3 mg of pure product LSP1-3131 were obtained (1% yield, 2 steps).

³¹P NMR (101 MHz, D₂O): δ (ppm)=46.0

¹H NMR (250 MHz, D₂O): δ (ppm)=1.45-1.79 (m; 2H; Hₐ), 1.94-2.03 (m; 2H; H_{b}), 3.69-3.84 (m; 1H; H_{c}), 4.35 (d; 2H; J=12 Hz; H_{d}), 7.62 (t; 1H; J=8 Hz; H_{g}), 7.78 (d; 1H; J=8 Hz; H_{f}), 8.20 (d; 1H; J=8 Hz; Hₕ), 8.27 (s; 1H; Hₑ)

MS (ESI): m/z=315.9 (M−1)

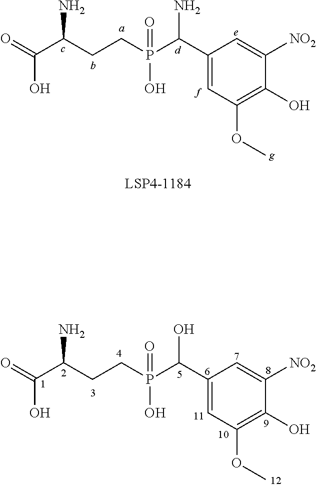

(2S)-amino-4-[[amino(4-hydroxy-5-methoxy-3-nitrophenyl)methyl](hydroxy) phosphoryl]butanoic acid LSP4-1184

The crude product 12 was deprotected according to general procedure D. The cation exchange column was eluted with 1N ammonia. 110 mg of pure product LSP4-1184 were obtained (89% yield, 2 steps).

³¹P NMR (101 MHz, D₂O): δ (ppm)=43.3

¹H NMR (500 MHz, D₂O): δ (ppm)=1.62 (m; 2H; Hₐ), 1.96 (m; 2H; H_{b}), 3.66 (s; 1H; H_{d}), 3.75 (s; 3H; H_{g}), 4.21 (s; 1H; H_{c}), 6.90 (s; 1H; H_{f}), 7.43 (s; 1H; Hₑ)

¹³C NMR (126 MHz, D₂O): δ (ppm)=24.8 (C₃), 25.5 (d; J=97.0 Hz; C₄), 55.4 (d; J=91.2 Hz; C₅), 56.4 (d; J=13.7 Hz; C₂), 115.1 (C₁₁), 119.0, 119.5, 136.3, 154.7, 156.3, 175.2 (C₁)

MS (ESI): m/z=361.9 (M−1)

### Activities on Metabotropic Glutamate Receptors 4, 8, 6 and 7.

Nitrobenzyl PCEP Derivatives

| | | | | mGl | | |
|---|---|---|---|---|---|---|
| | | mGlu4 | mGlu8 | u8/4 | mG1u6 | mG1u7 |
| | | EC₅₀ | EC₅₀ | EC₅₀ | EC₅₀ | EC₅₀ |
| Reference | structure | μM (n) | μM (n) | ratio | μM (n) | μM (n) |
| LSP1- 2093 | 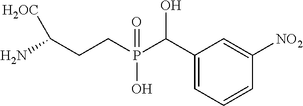 1^{st} batch 2^{nd} batch 3rd batch 4th batch 5th batch | 0.54 ± 0.05 (19) IP 0.57 ± 0.05 (3) IP 0.91 ± 0.09 (3) [symbol] 0.68 ± 0.32 (2) IP 0.71 ± 0.02 (2) [symbol] 0.87 ± 0.22 (2) [symbol] 1.0 ± 0.8 (2) [symbol] 0.6 ± 0.3 (2) [symbol] | 1.5 ± 0.5 (6) IP 2.3 ± 0.4 (10) [symbol] 1.7 ± 0.7 (2) [symbol] 1.8 ± 0.8 (2) [symbol] 2.6 ± 2.1 (2) [symbol] 1.2 ± 0.3 (2) [symbol] | 2.8 2.5 2.4 2.0 2.6 2.1 | 8.8 ± 0.7 (5) IP | >1000 (7) IP |
| LSP3- 1098-I | 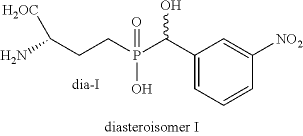 | 1.0 ± 0.4 (5) [symbol] | 1.25 ± 0.3 (5) [symbol] | 1.2 | | |
| LSP3- 1098-II | 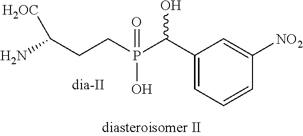 | 0.9 ± 0.4 (4) [symbol] | 1.3 ± 0.5 (5) [symbol] | 1.5 | | |
| LSP3- 1045 | 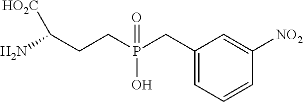 | 0.8 ± 0.2 (5) IP 0.42 ± 0.08 (7) [symbol] | 4.4 ± 2 (6) IP 1.0 ± 0.2 (6) [symbol] | 5.4 2.5 | | |
| LSP1- 3131 | 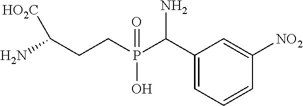 | 0.54 ± 0.14 (3) IP | 2.2 ± 0.9 (4) IP | 4.1 | | |
| LSP1- 2101 | 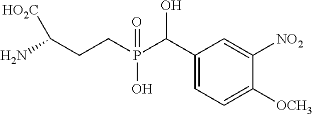 | 0.50 ± 0.09 (3) IP 4.2 ± 0.6 (3) [symbol] | 0.85 ± 0.07 (3) IP 4.4 ± 1.0 (3) [symbol] | 1.7 1.0 | | |
| LSP2- 6146-I | 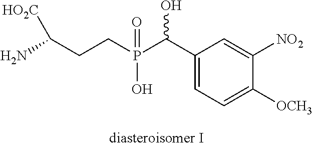 | 2.0 ± 0.4 (3) [symbol] | 2.5 ± 0.8 (3) [symbol] | 1.2 | | |
| LSP2- 6146-II | 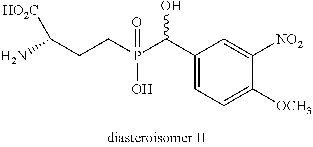 | 1.7 ± 0.6 (3) [symbol] | 2.2 ± 0.6 (3) [symbol] | 1.3 | | |
| LSP1- 2109 | 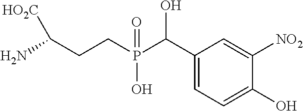 2^{nd} batch | 2.3 ± 0.3 (20) IP 5.2 ± 1.2 (3) [symbol] 1.9 ± 0.5 (3) IP 1.9 ± 0.5 (6) [symbol] | 42 ± 5 (14) IP 57 ± 4 (3) [symbol] 191 ± 97 (3) IP 69 ± 12 (4) [symbol] | 18.3 10.9 99 37 | 6.0 ± 0.9 (3) IP 6.3 ± 2.1 (4) [symbol] | 69 ± 8 (3) IP 125 ± 55 (4) [symbol] |
| LSP3- 2074-I | 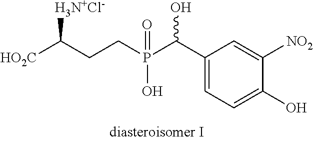 | 0.5 ± 0.07 (3) [symbol] | 31.5 ± 8.6 (3) [symbol] | 63 | 3.9 ± 1.7 (4) [symbol] | 62 ± 26 (3) [symbol] |
| LSP3- 2074-II | 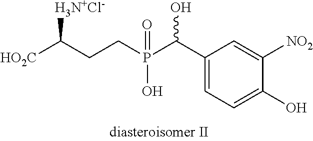 | 4.5 ± 0.2 (3) [symbol] | 39.8 ± 6.5 (4) [symbol] | 8.5 | 68.4 ± 14.5 (3) [symbol] | 295 ± 178 (3) [symbol] |
| LSP1- 2111 | 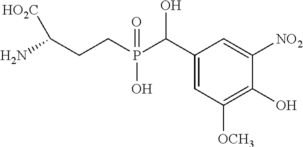 | 2.2 ± 0.3 (26) IP 2.6 ± 1.0 (3) [symbol] 1.3 ± 0.3 (5) [symbol] 1.5 ± 0.1 (5) 2.5 ± 1.2 (4) [symbol] 0.52 ± 0.01 (2) [symbol] | 66 ± 12 (16) IP 43 ± 12 (3) [symbol] 21 ± 5 (4) [symbol] 113 ± 52 (3) 142 ± 125 (3) [symbol] 20 ± 3 (3) [symbol] | 30 16 16 73 58 40 | 1.7 ± 0.1 (3) IP 3.18 ± 1.43 (4) [symbol] | 53 ± 20 (3) IP 101 ± 33 (3) [symbol] |
| LSP3- 1101-I | 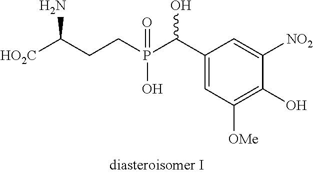 | 0.74 ± 0.09 (5) [symbol] | 23 ± 6 (5) [symbol] | 31 | 1.11 ± 0.41 (4) [symbol] | 63 ± 35 (3) [symbol] |
| LSP3- 1101-II | 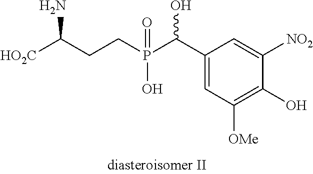 | 4.7 ± 0.4 (5) [symbol] | 27 ± 14 (5) [symbol] | 5.9 | 2.36 ± 0.77 (4) [symbol] | 100 ± 49 (3) [symbol] |
| LSP3- 2134 | 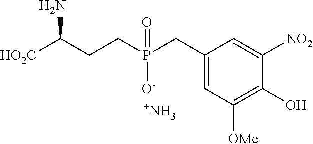 | 19.7 ± 10.5 (2) [symbol] | 16.6 ± 1.1 (2) [symbol] | 0.85 | | |
| LSP4- 1184 | 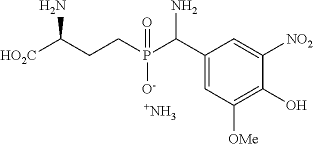 | 13.0 ± 3.9 (2) [symbol] | 33 ± 12 (6) [symbol] | | inactive | inactive |
| LSP3- 1145 | 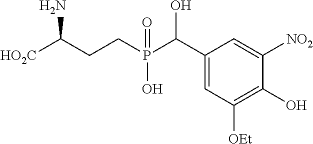 | 8.5 ± 1.1 (3) [symbol] | 27 ± 20 (2) [symbol] | 3.1 | | |
| LSP3- 1143-I | 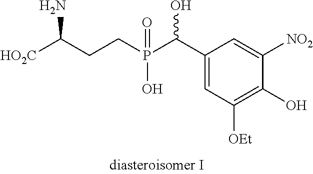 | 5.1 ± 1.2 (3) [symbol] | 33 ± 31 (2) [symbol] | 6.5 | | |
| LSP3- 1143-II | 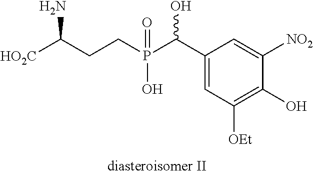 | 6.4 ± 2.4 (3) [symbol] | 9.2 ± 2.6 (2) [symbol] | 1.4 | | |
| LSP3- 3099 | 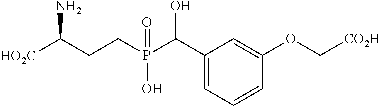 | 7.6 ± 2.0 (3) [symbol] | 71 ± 25 (3) [symbol] | 9.4 | | |
| LSP3- 3108-I | 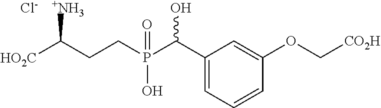 | 4.9 ± 1.0 (4) [symbol] | 36 ± 18 (4) [symbol] | 7.4 | | |
| LSP3- 3108-II | 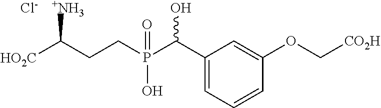 | 13.0 ± 2.9 (3) [symbol] | 29.3 ± 7.2 (3) [symbol] | 2.3 | | |

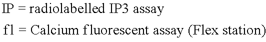

1. Diastereoisomers of hypophosphorous acid derivatives, having formula (I) 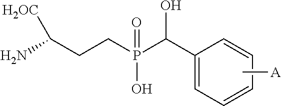
wherein the phenyl group is substituted by one or several atoms or groups, occupying one or several positions on the phenyl ring.

2. The diastereoisomers of claim 1, wherein the phenyl ring is substituted by alkoxy groups —COA, with A being a C1-C12 alkyl, optionally substituted, for example by a functional group such as a carboxyl group.

3. Diastereoisomers of the following derivatives: (3S)-3-[(((3-ammonium-3-carboxy)propyl)(hydroxy)phosphinyl)-hydroxymethyl]3-nitrobenzene hydrochloride; (3S)-3-[(((3-ammonium-3-carboxy)propyl)(hydroxy)phosphinyl)-hydroxymethyl]4-hydroxy-3-nitrobenzene hydrochloride; (3S)-3-[(((3-ammonium-3-carboxy)propyl)(hydroxy)phosphinyl)-hydroxymethyl]4-hydroxy-5-methoxy-3-nitrobenzene hydrochloride; (3S)-3-[(((3-ammonium-3-carboxy)propyl)(hydroxy)phosphinyl)-hydroxymethyl]4-hydroxy-5-ethoxy-3-nitrobenzene hydrochloride.

4. A method for the separation of diastereoisomers of hypophosphorous acid derivatives comprising performing a semi-preparative HPLC chromatography in a column, at a pH of 1.5 to 2.5, at a flow rate of 1-2.5 mL.min⁻¹.

5. The method of claim 4, wherein the pH is of about 2.0.

6. The method of claim 4, wherein the flow rate of about 1.5-2 mL min⁻¹.

7. The method of claim 4, wherein the HPLC column comprises an injection loop.

8. The method of claim 4, wherein the HPLC column further comprises a dual UV detection, particularly at 210 and 254 nm.
